(19) United States
(12) Patent Application Publication
(10) Pub. No.: US 2022/0253101 A1
(43) Pub. Date: Aug. 11, 2022

(54) Portable Triple Mount

(71) Applicant: Joseph Atias, Great Neck, NY (US)

(72) Inventor: Joseph Atias, Great Neck, NY (US)

(21) Appl. No.: 17/172,081

(22) Filed: Feb. 10, 2021

(51) Int. Cl. G06F 1/16

(52) U.S. Cl. CPC G06F 1/1647; G06F 1/1607

(57) ABSTRACT

The present invention relates to a multiple monitor display apparatus in the form or a laptop PC, a desktop monitor, a mobile device, and the like. In triple screen mode, the additional monitor is typically presented displaying different content and centered to the user. In single screen mode, the additional display enclosures are retracted and stored in such a manner that they do not present themselves to the user. A guiderail assembly is used to center all display enclosures relative to the user. The guiderail assembly may be motorized or manually effected and may be located above or below the primary enclosure hinge. The secondary enclosure may be extended and retracted from the primary enclosure by the use of slider arms. The tertiary enclosure may be extended and retracted from the primary enclosure by the use of slider arms. Independent Hinge that connects both the main holder and side holder have their own swivel mechanism so that the user can change the placement of the monitor according to what the user prefers. In one embodiment, the monitor may be rotated from landscape to portrait view.

### COPYRIGHT NOTICE

A portion of the disclosure of this patent document contains material which is subject to copyright protection. The copyright owner has no objection to the facsimile reproduction by anyone of patent disclosure, as it appears in the Patent and Trademark Office patent files or records, but otherwise reserves all copyright rights whatsoever.

### BACKGROUND

### Field of the Invention

The present invention relates to computing devices; more particularly, the present invention relates to computing devices stand that provides at least three displays panels.

### Description of the Related Art

A typical user interface in most portable computing devices has a single display for a human user to view data and a keyboard for the human user to enter data. However, almost all graphics cards, graphics controllers, and graphics processors sold today support multiple displays.—i.e., a user of any computer device having one of these cards, controller or processor can easily connect more than one display to the computing device. In addition, the, price of display panels has recently become low enough to make a multi-display environment affordable and to make possible many interesting applications. As a result, portable devices for games with two or more displays have been introduced (e.g., the Nintendo DS). Similarly, dual-screen notebook devices (e.g., the Acer Iconia) use the additional screen to provide additional viewable areas or to provide an on-screen virtual keyboard. However, these dual-display devices use the additional display mainly to provide additional viewable areas for a single user and support neither sharing of the additional display for use with multiple users, nor providing flexible display settings available in the dynamic multi-display environment.

Tablet devices, such as Apple Computer's “iPad,” are recently popularized computing devices with both a form factor and a computing power that rank between smartphones and notebooks. Following on the tablet devices are “hybrid laptops,” which are portable computing devices that can dynamically serve as either a “netbook” or a tablet, as required. As known to those skilled in the art, a netbook is a notebook computer customized for internet access applications. These hybrid laptops typically allow the display to be either detached from the keyboard body (e.g., the Lenovo's IdeaPad, or the ASUS Eee Pad Transformer) or “flipped around” to become a tablet (e.g., Dell Inspiron Duo flip-screen laptop). Some of these hybrid laptops support dynamic device and display setting.

These multiple-screen notebooks, detachable tablets, and flip-screen laptops enable a single computing device to be used by a single user in both notebook and tablet device applications, supporting increased viewable areas and virtual keyboard features.

There are limited solutions that have been presented in prior art. However, these solutions are limited and restricted to their conventional architecture, installation system and have considerable shortcomings which adversely affect the convenience with which they can be used. The prior systems have certain limitations including solutions that are limited and restricted limited circumstances. Moreover, the ease-of-use ability of these assemblies is also questionable.

The present invention discloses a means to provide a triple mount for screens for any type of computing device. Embodiments described herein generally relate to monitor screen mounting systems and methods. According to one aspect, a multi-screen mounting system is provided. The mounting system includes multiple support arm having a first end and a second end and a screen mount configured to attach to the support arm.

None of the previous inventions and patents, taken either singly or in combination is seen to describe the instant invention as claimed. Hence, the inventor of the present invention proposes to resolve and surmount existing technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of multiple screens mounting system.

Another object of the present invention is to provide an improved form of a method consistent with the present invention to provide an improved mounting system which is provided having projection base and an extension arms interconnected to form an extensible arm assembly.

Another object of this invention is to provide a new and improved extension arm assembly which is longitudinally movable relative to the projection base to extend and retract between a fully extended position and a fully retracted position.

It is a further object and feature of the present invention to provide a flexible assembly which supports more than one user to simultaneously view and interact with different or the same content from the multiple display panels.

It is further the objective of invention to provide a hard-shell protective case that is reliable and can hold multiple monitors without any risk of damage.

It is a still further object and feature of the present invention to provide a triple mounting system which can be simply and easily used by any user.

It is further objectives of the present invention to provide an assembly which is easy to use, and does not have the disadvantages of as seen in prior art.

It is a further aspect of the present invention to provide a new and improved assembly which is based on reliable material and maintains its safety standards even after persistent use.

Thus, it is the objective to provide a new and improved system of triple mounting stand for desktop systems. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a perspective view of the triple mount stand in multiple views as per preferred embodiments of the invention.

FIG. 2 is showing multiple views of stand assembly as per preferred embodiments of the invention.

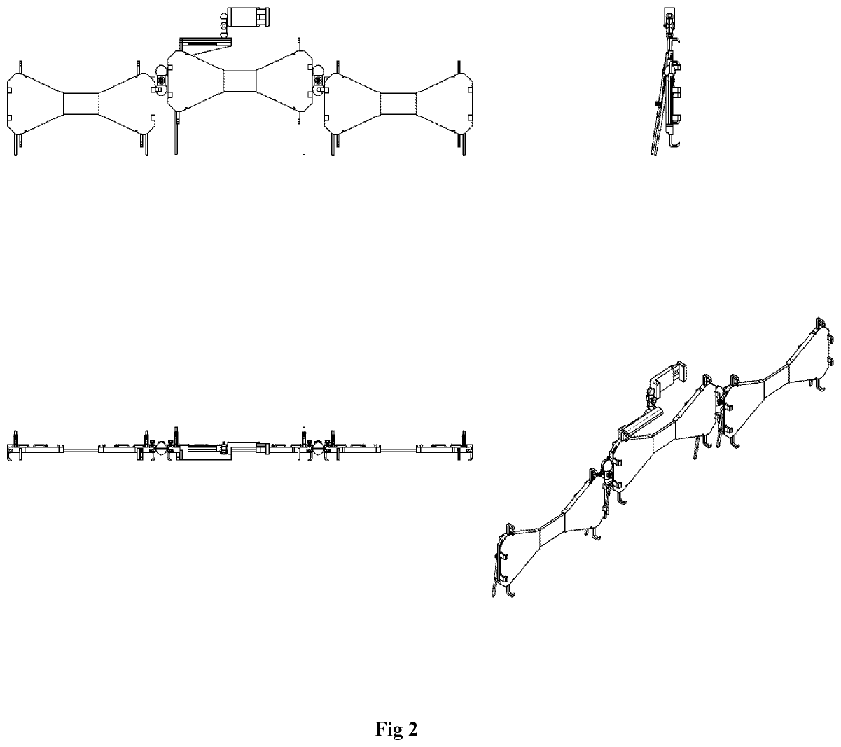

FIG. 3 is showing multiple views of triple mount stand and holding clamp as per preferred embodiments of the invention.

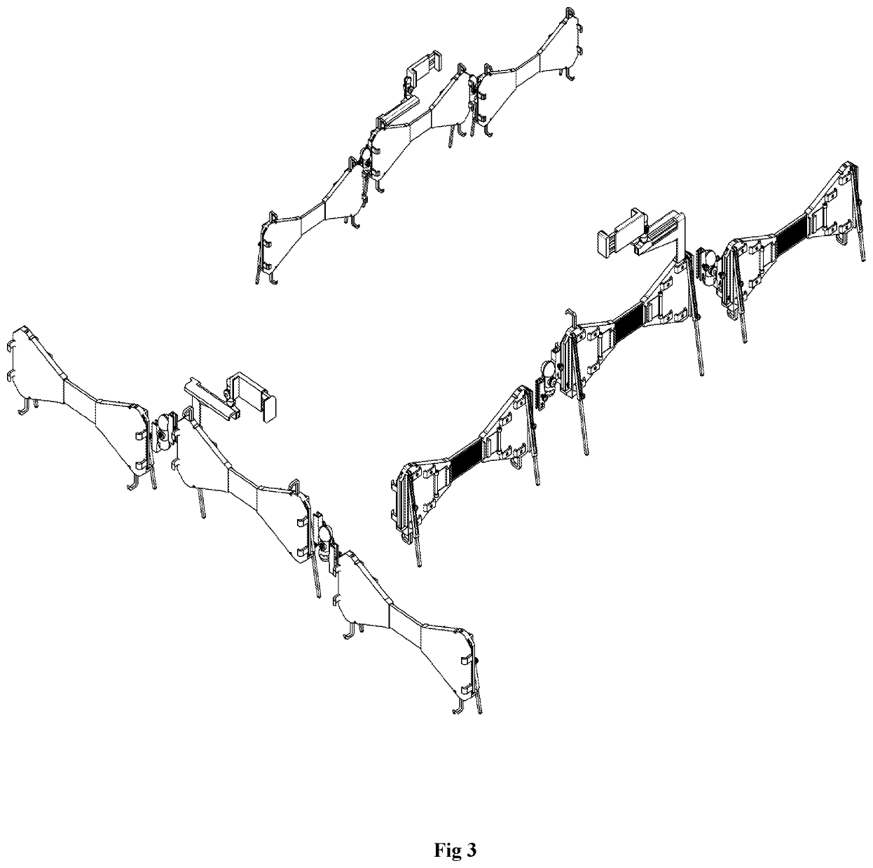

FIG. 4 is showing multiple views of holding arm as per preferred embodiments of the invention.

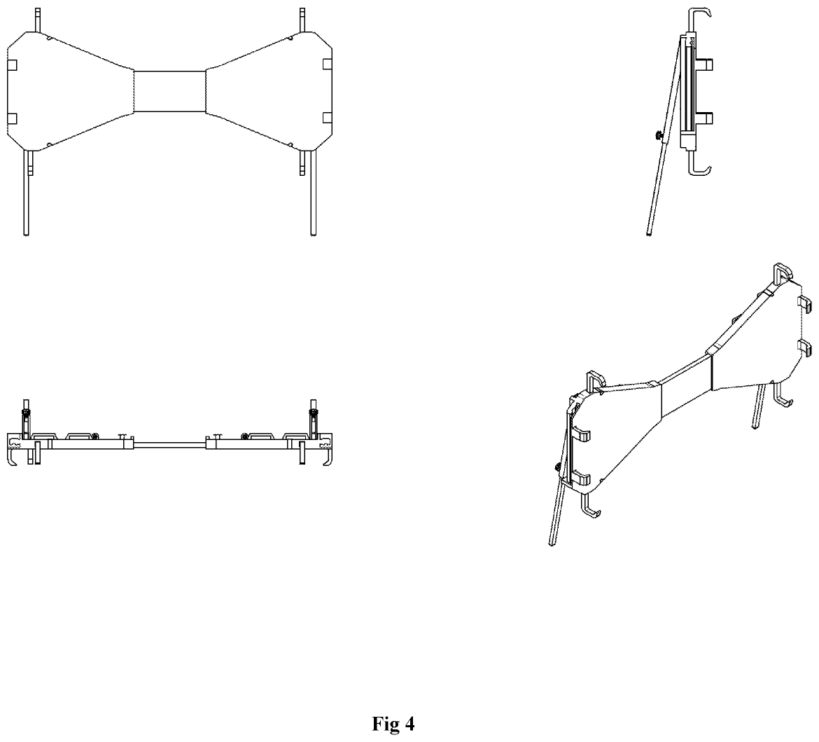

FIG. 5 is showing multiple front and back views of holding arm and its attachments as per preferred embodiments of the invention.

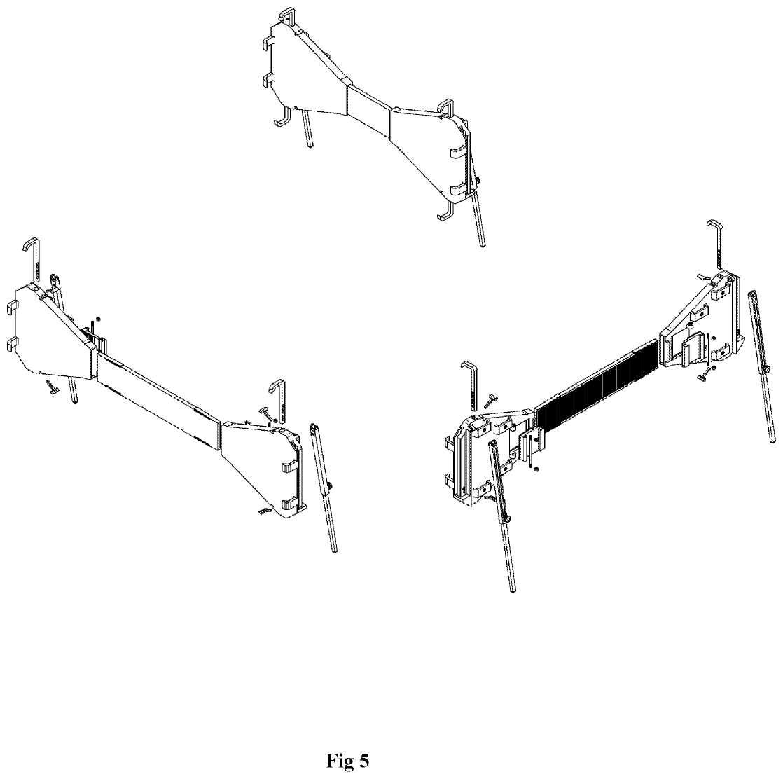

FIG. 6 is showing multiple views of holding arm as per further embodiments of the invention.

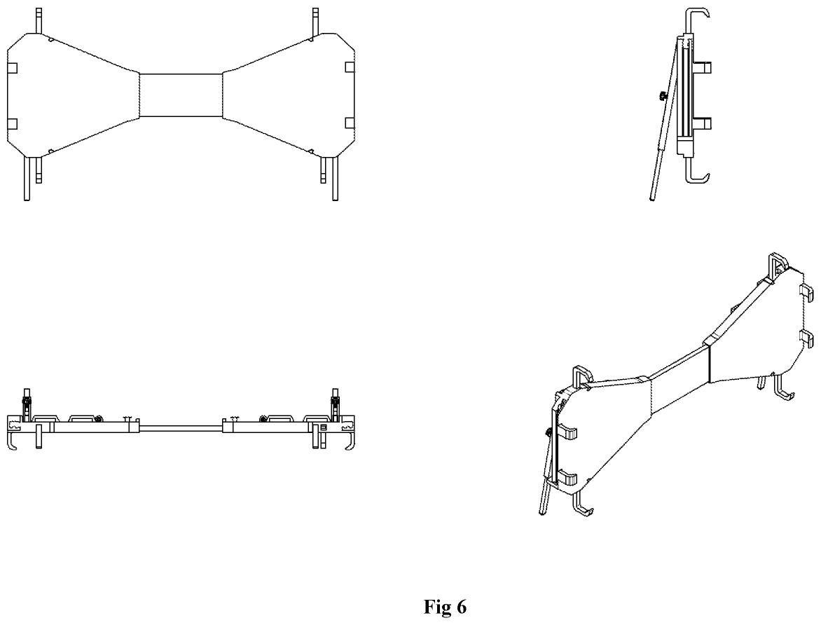

FIG. 7 is showing additional views of holding arm and its attachments as per preferred embodiments of the invention.

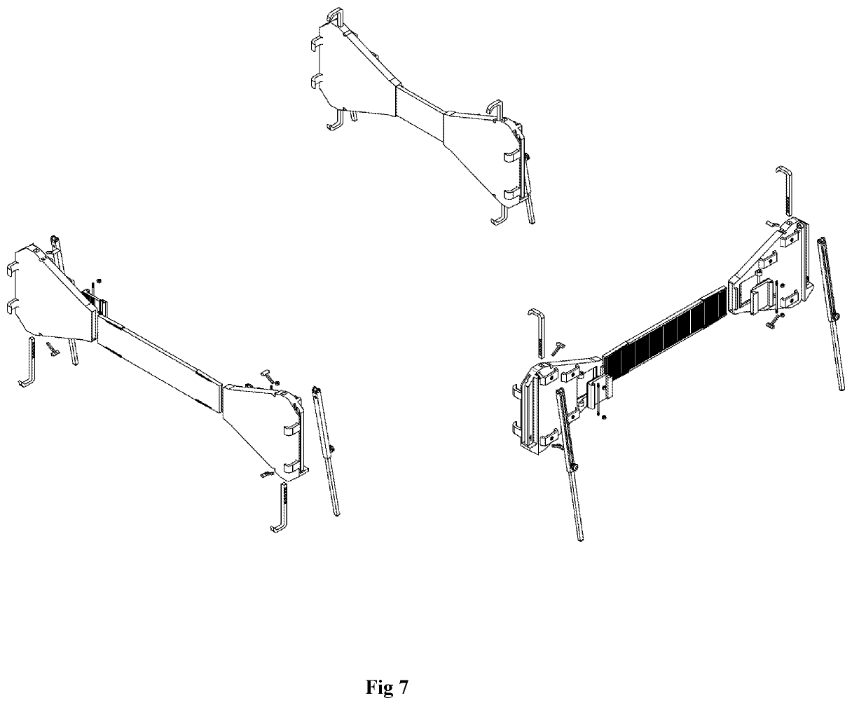

FIG. 8 is showing multiple front and back views of clamping portion for screens as per preferred embodiments of the invention.

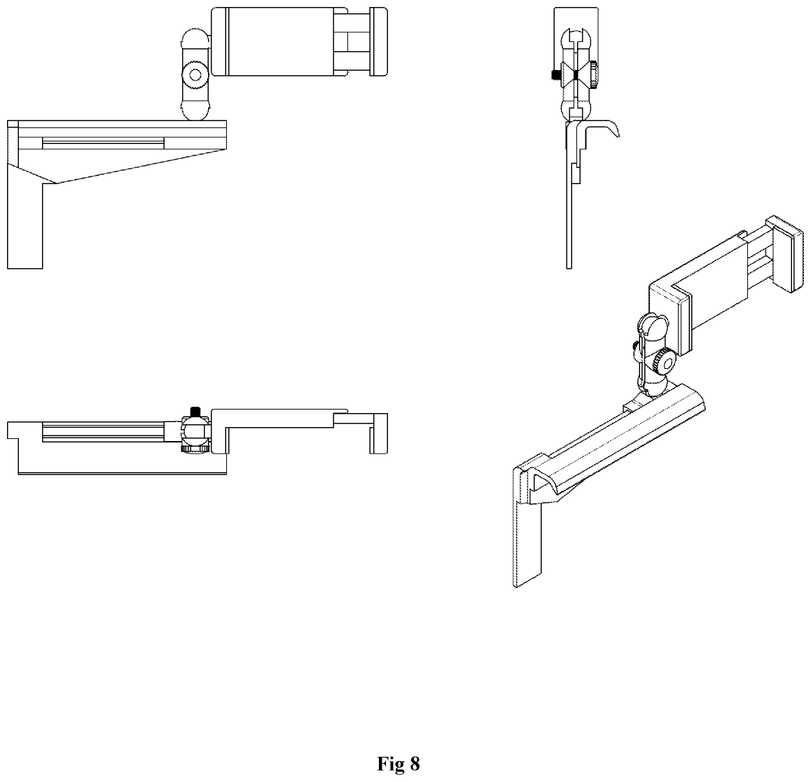

FIG. 9 is showing phone holder-swivel mechanism as per preferred embodiments of the invention.

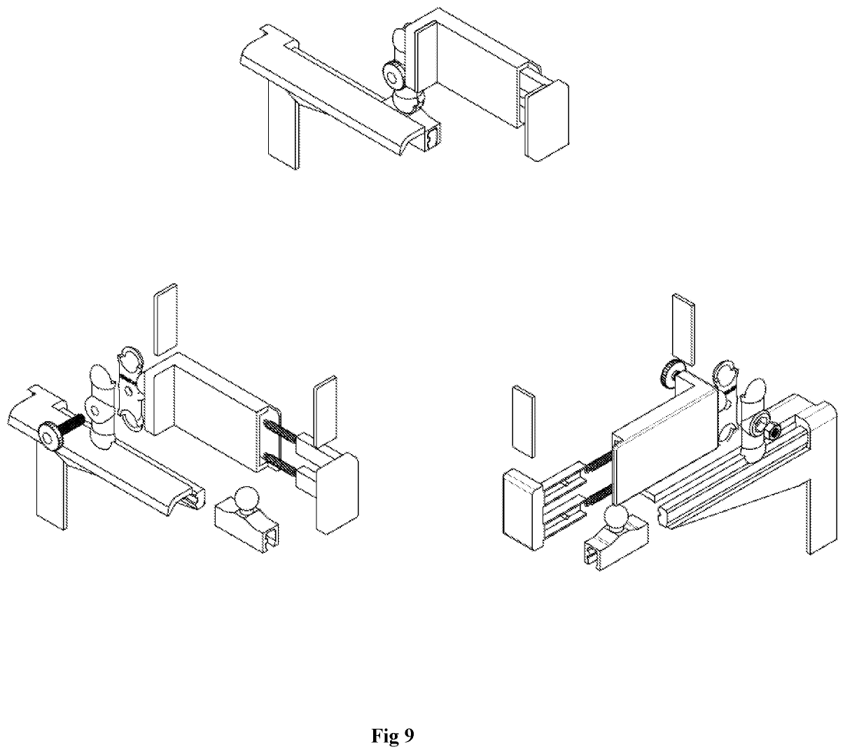

FIG. 10 is showing attachment part of triple mount assembly as per preferred embodiments of the invention.

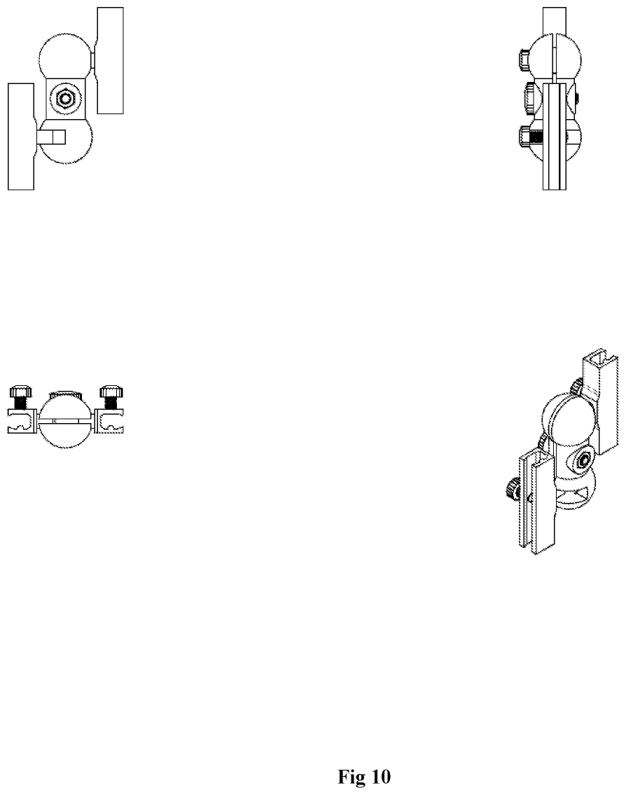

FIG. 11 is showing another attachment part of triple mount assembly as per preferred embodiments of the invention.

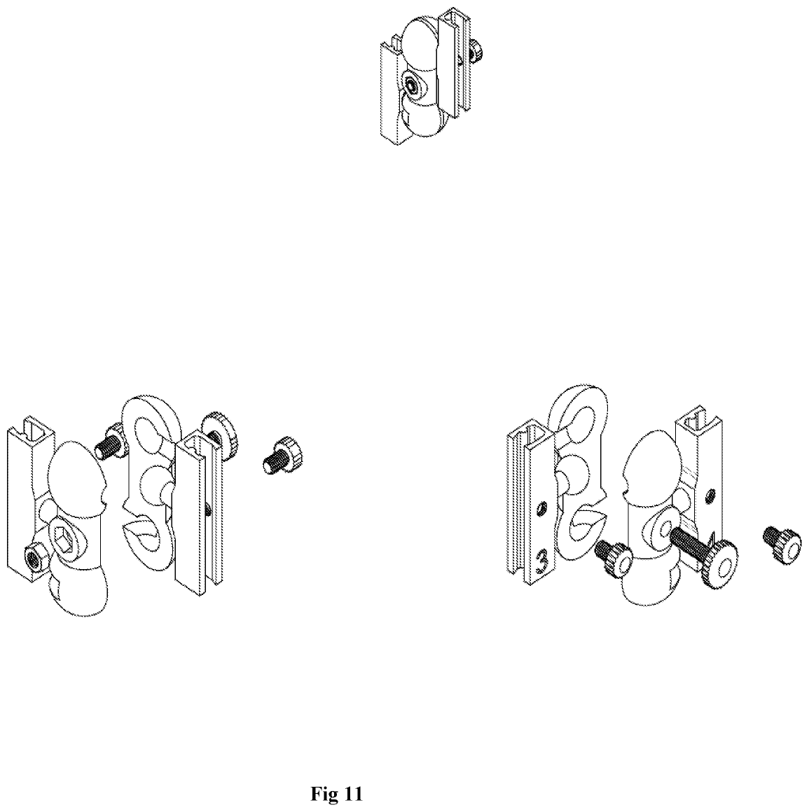

FIG. 12 is showing additional attachment part of triple mount assembly as per preferred embodiments of the invention.

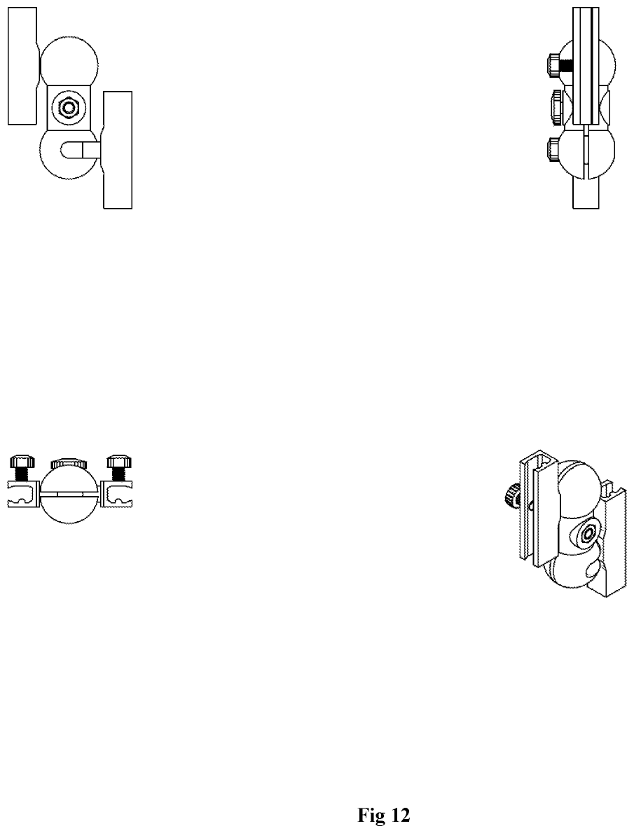

FIG. 13 is showing multiple screws configured with as per preferred embodiments of the invention.

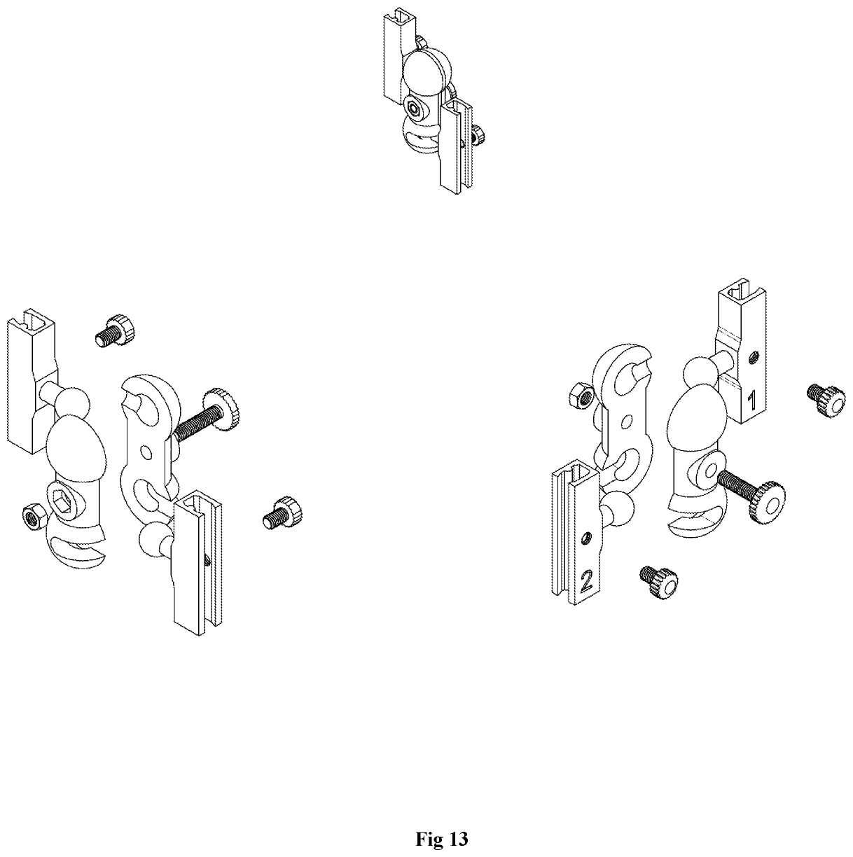

FIG. 14 is showing extendable parts of triple mount assembly as per preferred embodiments of the invention.

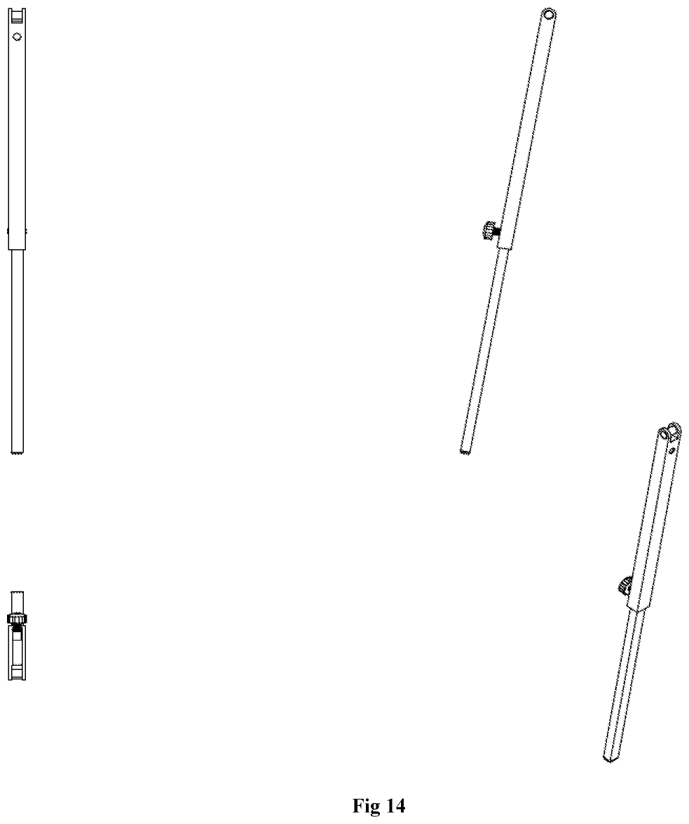

FIG. 15 is showing another view of extendable arms and their attachments of triple mount assembly as per preferred embodiments of the invention.

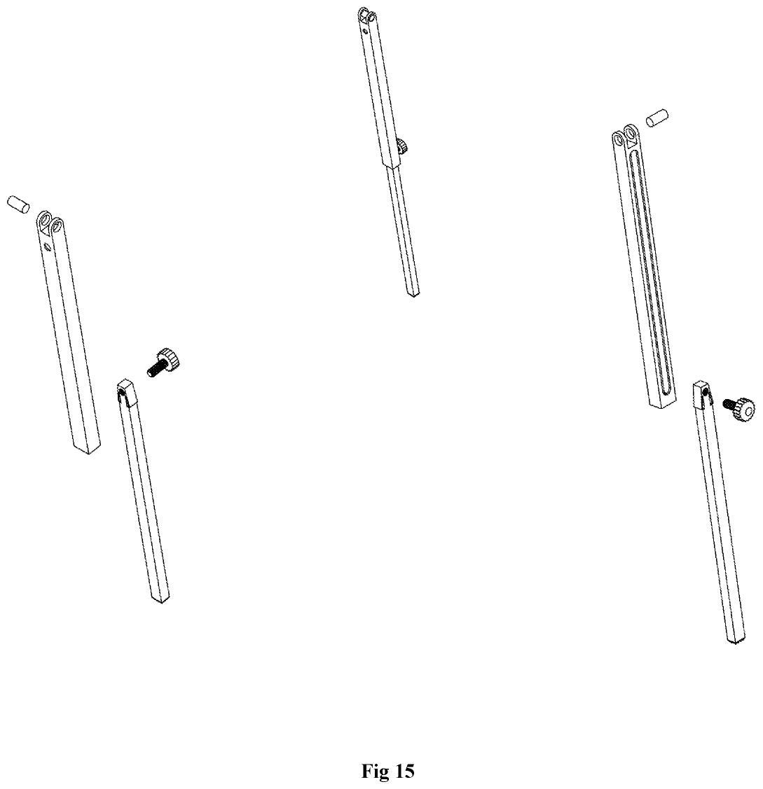

FIG. 16 is showing the three screens and mounting assembly as per preferred embodiments of the invention.

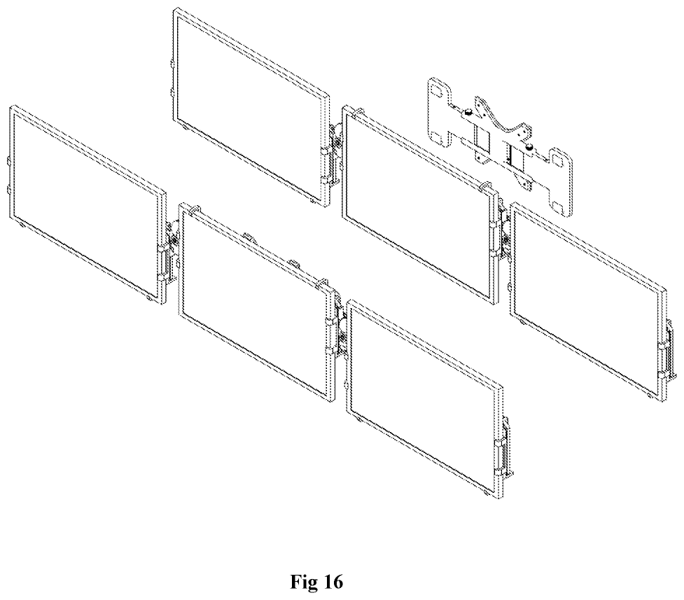

FIG. 17 is showing holder view compatible with triple mounting assembly as per preferred embodiments of the invention.

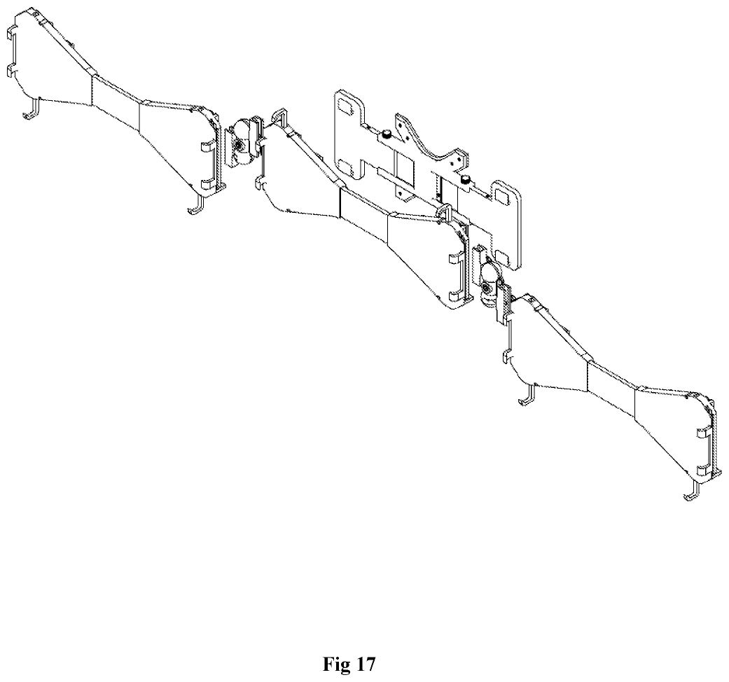

FIG. 18 is showing the holder's arm connected with triple mount assembly as per preferred embodiments of the invention.

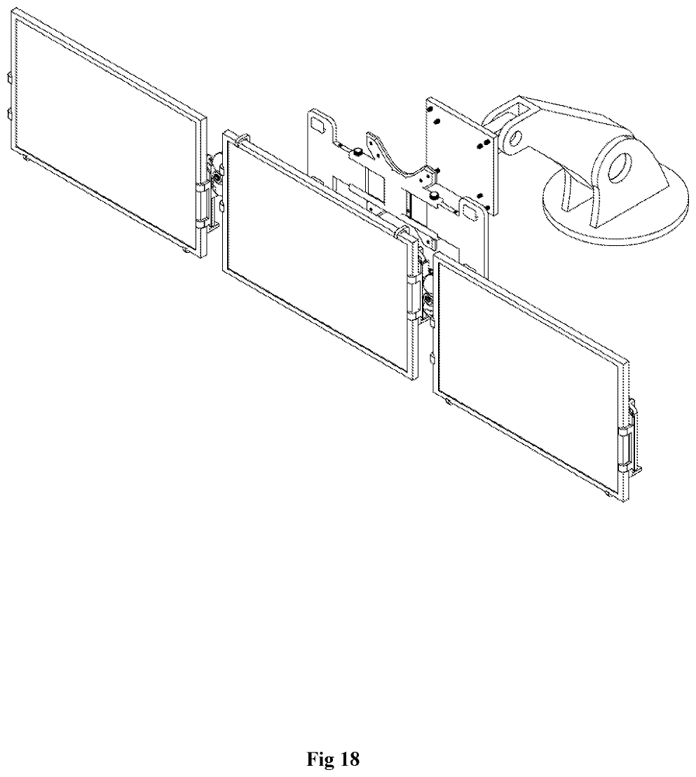

FIG. 19 is showing the back view of holder's arm connected with triple mount assembly as per preferred embodiments of the invention.

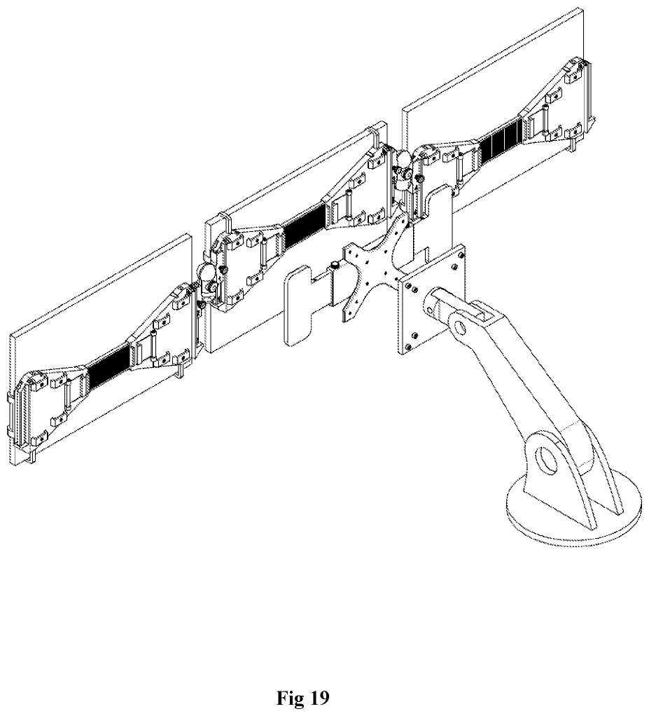

FIG. 20 is showing detachable view of holder's arm and attachments of triple mount assembly as per preferred embodiments of the invention.

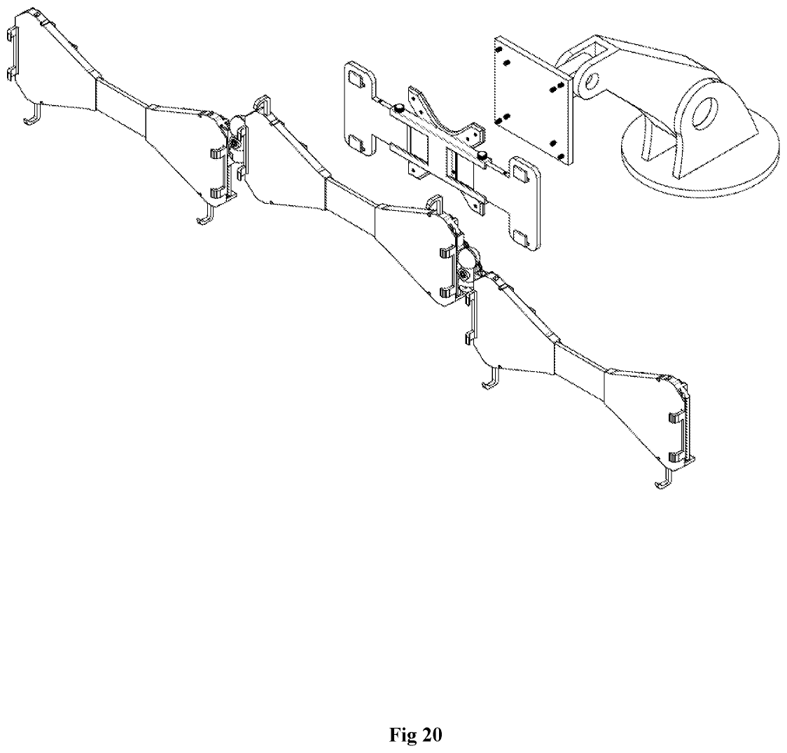

FIG. 21 is showing detachable view of holder's arm and hand of triple mount assembly as per preferred embodiments of the invention.

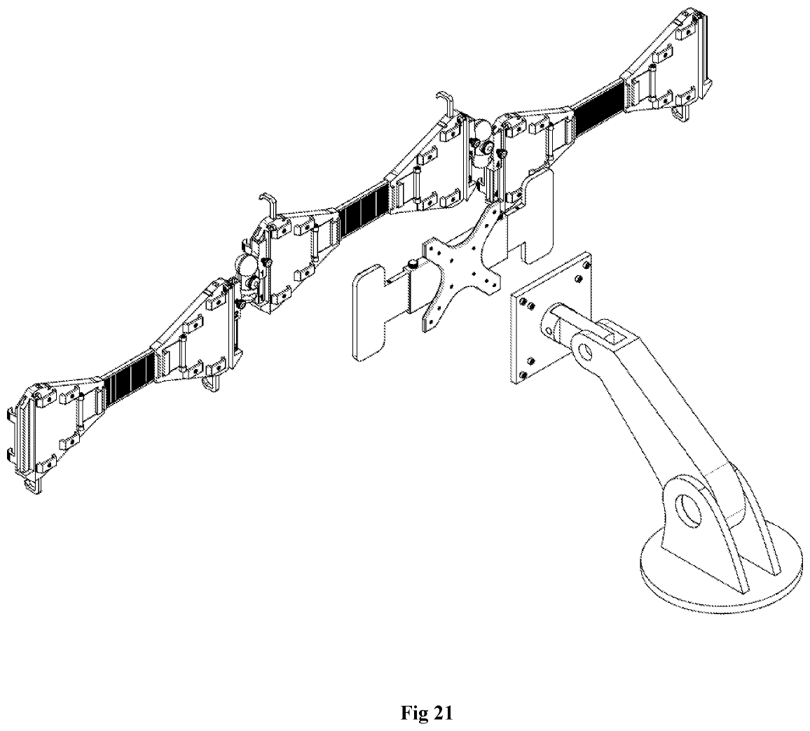

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Many professionals utilize two or more computers monitors at the office. Such professionals include securities traders, architects, computer programmers, marketing or sales representatives, and the like. Similarly, professionals who utilize multiple monitors at the office may desire similar features when they travel or visit a client's premises. As the price of computer monitors such as LCD monitors fall, and new thinner display technologies such as OLEDs become technically viable, more and more professionals will see the need to work or monitor data on multiple display screens.

For some professionals, there may only be an occasional need for using multiple monitor displays, for example, during certain tasks, or during certain times of the day. However, setting up two or more monitors and storing them later after their intended use is time consuming and inconvenient. Multiple monitors require space, and use precious desktop surface area. Furthermore, multiple monitors may impede vision or increase clutter around a desk.

The present invention as per its preferred embodiments discloses a method of mounting multiple screens at a single stand assembly. A multiple monitor apparatus, typically in the form of a triple screen display apparatus, is disclosed along showing numerous variations in the arrangement of the apparatus components within the scope of the invention. Such an apparatus is suited for applications where multiple display screens are preferred or occasionally required in a portable housing and that the additional display screen(s) may be readily accessed, operated, and then stored in a quick and efficient manner. Access implies opening or extending the associated display; Storing implies closing or retracting the associated display.

The triple screen display apparatus of the present invention may be described as similar to a conventional monitor screen but comprised of three display screens: a primary display screen fixedly attached to a primary enclosure, a secondary display screen fixedly attached to a secondary enclosure and a Tertiary display screen attached to the tertiary enclosure. The primary display screen may be used as a typical display screen while the secondary and tertiary display screens may be an identical display screens or a specialized display screen. The secondary and termitary display screens may be used simultaneously, concurrently, and in complementary fashion with the activities of the first display screen or the second display screen or the Tertiary display screen may be used as a distinct, separated, or specialized separate display unit.

As will be explained hereafter, there are other examples of dual screen display apparatuses consistent with the present invention mentioned such as a triple screen slate style table PC apparatus, triple screen mobile phone apparatus, triple screen PDA/smart phone apparatus, triple screen wall mount apparatus, triple screen desktop apparatus, or simply triple screen apparatus. The terms “triple screen display apparatus” and “triple screen apparatuses are used interchangeably to refer to the present invention.

The first preferred embodiment concerns a triple screen display apparatus comprising an extendable triple enclosure housed within the primary enclosure. The secondary enclosure may be exited beyond or outside of the primary enclosure via slider arms, support arms, hinges or telescopic arms. The tertiary enclosure may be exited beyond or outside of the primary enclosure via slider arms, support arms, hinges or telescopic arms.

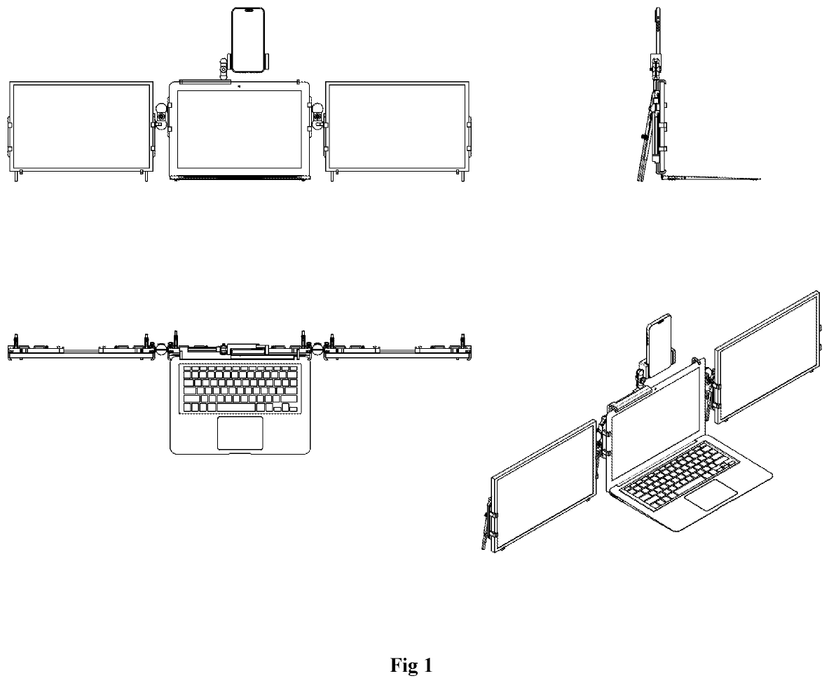

Accordingly, FIG. 1 is an isometric view of multiple screen apparatus incorporating guiderail assembly located below primary enclosure hinge, single screen mode, in accordance with the first preferred embodiment of the present invention. In a single screen mode, as depicted in FIG. 1, the user generally relies on utilizing multiple display screens When triple screen apparatus is opened, primary display screen is the first display screen visible to the user. It is always visible in other alternative embodiments as in the case of a display screen mounted on a wall, desktop stand, partition, or pedestal.

The adjustment method of screens is depicted from below description.

Once the lever is opened, none of its teeth has contact with the teeth the slider, wherein the slider can be adjusted to the desired length while it is placed on the monitor. As the door comes down after adjusting the length to the desired length, when the lever is partially closed the teeth on the side of the lever will touch the closest teeth on the slider hereby adjusting the slider a millimeter closed to have a good grip. After the lever is closed, the teeth of the lever and the slider will be locked in place.

The hinge-swivel mechanism works as per preferred embodiments in a way where Hinge connects both the main holder and side holder have their own swivel mechanism so that the user can change the placement of the monitor according to what the user prefers.

The Hinge uses a ball joint so that the holder can swivel up and down and also sideways. The limitation of the movement for sideways is 45 degrees from when the side holder is parallel with the main holder.

The holder can swivel horizontally to 180 degrees on the bottom and on the top and can be locked in place by a thumb screw with two plates that squeezes them togethers as shown. It also has a clamp mechanism that uses two extension springs to grip the mounted assembly.

The side plates of the hinge as per its further embodiments can also slide and can be locked in place with the use of the thumb screw.

The Hinge as per its further embodiments uses a ball joint so that the holder can swivel up and down and also sideways. The limitation of the movement for sideways is 45 degrees from when the side holder is parallel with the main holder

The upper support leg for the main holder hangs on the monitor on the middle and the lower support leg on the side holders carry the weight of the side monitors which in turn provide unique weight balancing on the structure. The extended leg has its own sliding mechanism so that it can support the structure from tipping. The slider can be adjusted to 9 cm.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A multiple monitor display apparatus comprising a primary enclosure and its associated display screen, a secondary enclosure and its associated display screen; a tertiary enclosure and its associated display screen, a guiderail assembly for electively, centering said primary enclosure, said secondary enclosure and said tertiary enclosure with respect to a user, swivel means to rotate the secondary and tertiary enclosure with respect to the primary enclosure and with respect to the user, and cabling means to supply power to the secondary enclosure and its display screen.

2. The multiple monitor display apparatus of claim 1 wherein door/lever lock mechanism is presented;

3. The multiple monitor display apparatus of claim 1 wherein once the lever is opened, none of its teeth has contact with the teeth the slider, wherein the slider can be adjusted to the desired length while it is placed on the monitor;

4. The multiple monitor display apparatus of claim 1 wherein after adjusting the length to the desired length, when the lever is partially closed the teeth on the side of the lever will touch the closest teeth on the slider hereby adjusting the slider a millimeter closed to have a good grip;

5. The multiple monitor display apparatus of claim 1 wherein after the lever is closed, the teeth of the lever and the slider will be locked in place;

6. The multiple monitor display apparatus of claim 1 wherein said Hinge connects both the main holder and side holder have their own swivel mechanism;

7. The multiple monitor display apparatus of claim 1 wherein user can change the placement of the monitor according to what the user prefers;

8. The multiple monitor display apparatus of claim 1 wherein said Hinge uses a ball joint so that the holder can swivel up and down and also sideways.

9. The multiple monitor display apparatus of claim 1 wherein said holder can swivel horizontally up to 180 degrees on the bottom and on the top and can be locked by thumb screw.
